(19) United States
(12) Patent Application Publication
(10) Pub. No.: US 2024/0347245 A1
(43) Pub. Date: Oct. 17, 2024

(54) ENVIRONMENTALLY FRIENDLY MAGNETORHEOLOGICAL FLUID

(71) Applicant: CK MATERIALS LAB CO., LTD., Ansan-si, Gyeonggi-do (KR)

(72) Inventors: Hyeong Jun KIM, Ansan-si, Gyeonggi-do (KR); Young Chul CHA, Ansan-si, Gyeonggi-do (KR); Seong Jun SHIN, Ansan-si, Gyeonggi-do (KR); Jeong Hoon KIM, Ansan-si, Gyeonggi-do (KR)

(21) Appl. No.: 18/686,451

(22) PCT Filed: Jan. 9, 2024
(86) PCT No.: PCT/KR2024/000389

§ 371 Date: Feb. 26, 2024

(30) Foreign Application Priority Data
Jan. 10, 2023 (KR) 10-2023-0003546
Jan. 8, 2024 (KR) 10-2024-0002678

(51) Int. Cl. H01F 1/44

(52) U.S. Cl. CPC H01F 1/447

(57) ABSTRACT

The present invention relates to a magnetorheological fluid. The magnetorheological fluid according to the present invention is a magnetorheological fluid whose flow characteristics change in response to the application of an external magnetic field, the magnetorheological fluid including: a dispersion medium containing oil; magnetic particles; and an additive, wherein the oil has a triglyceride structure composed of ester bonds between glycerol and fatty acid.

### TECHNICAL FIELD

The present invention relates to an environmentally friendly magnetorheological fluid. More specifically, the present invention relates to an environmentally friendly magnetorheological fluid that utilizes an environmentally friendly dispersion medium, can reduce manufacturing costs, has a high flash point, and can be used stably over a wide temperature range.

### BACKGROUND ART

A magnetorheological fluid (MRF), as a suspension in which micro-sized magnetic particles sensitive to magnetic fields are mixed in a dispersion medium such as oil or water, is one of smart materials whose flow characteristics can be controlled in real-time by applying an external magnetic field.

The magnetorheological fluid exhibits a magnetorheological phenomenon in which a rheological behavior, as well as electrical, thermal, and mechanical properties, change according to the external magnetic field. In general, when no external magnetic field is applied, a magnetorheological fluid exhibits Newtonian fluid properties. However, when an external magnetic field is applied, magnetic particles inside the magnetorheological fluid form a chain structure in a direction parallel to the applied magnetic field, resulting in a shear force that inhibits the flow of the fluid or resistance to flow and exhibiting the properties of Bingham fluids that generate a constant yield stress even without a shear strain.

Magnetorheological fluids, due to their resistance to flow, rapid response time, and reversible characteristics, have high potential for application in various industries such as vibration control devices like dampers, automotive clutches, brakes, and more. Particularly, they are actively applied in shock absorbers for automobiles.

Conventional magnetorheological fluids primarily use synthetic oil as the dispersion medium. However, hydrocarbon-based synthetic oils are difficult to decompose, leading to challenges in disposal and environmental pollution, and there is also a risk of significant accidents such as explosions in the event of a fire.

### DETAILED DESCRIPTION OF THE INVENTION

### Technical Problem

An object of the present invention is to provide an environmentally friendly magnetorheological fluid that uses an environmentally friendly dispersion medium and can reduce manufacturing costs.

Additionally, an object of the present invention is to provide an environmentally friendly magnetorheological fluid capable of stable use in a high temperature range, with a relatively high flash point.

Moreover, an object of the present invention is to provide an environmentally friendly magnetorheological fluid capable of preventing sedimentation of magnetic particles, with relatively high viscosity and density.

However, these objects are exemplary and the scope of the present invention is not limited thereto.

### Technical Solution

The objects of the present invention are achieved by a magnetorheological fluid whose flow characteristics change in response to the application of an external magnetic field, the magnetorheological fluid including a dispersion medium containing oil;

magnetic particles; and an additive, wherein the oil has a triglyceride structure composed of ester bonds between glycerol and fatty acid.

According to an embodiment of the present invention, the oil may include at least one of the following: rapeseed oil (canola oil or colza oil), soybean oil, linseed oil, peanut oil, cottonseed oil, corn oil, olive oil, coconut oil, soya oil, palm oil, grape seed oil, sunflower seed oil, safflower oil, hazelnut oil, marula oil, macadamia oil, mongongo oil, argan oil, almond oil, pine nut oil, cashew oil, pistachio oil, pecan oil, walnut oil, rice bran oil, mustard oil, neem oil, perilla oil, hemp seed oil, watermelon seed oil, avocado oil, sesame oil, palm kernel oil, castor oil, pumpkin seed oil, lemon oil, and orange oil.

According to one embodiment of the present invention, the magnetic particles may include iron, carbonyl iron, iron alloy, iron oxide, iron nitride, iron carbide, low carbon steel, nickel, cobalt, and mixtures thereof or alloys hereof.

According to one embodiment of the present invention, the additive may include a pour point depressant.

According to one embodiment of the present invention, the pour point depressant may be contained in an amount of 0.1 wt % to 3.0 wt % in the magnetorheological fluid.

According to one embodiment of the present invention, the pour point depressant may be contained in an amount of 0.5 wt % to 2.5 wt % in the magnetorheological fluid.

According to one embodiment of the present invention, the additive may include poly alkyl methacrylate (poly alkyl methacrylate), or include any one of vinyl carboxylate-dialkyl fumarate copolymers, alpha-olefin polymers and copolymers, dichlorobenznene, toluene, ethylene glycol monoethyl ether, dichloromethane, dichloroethane, wax alkylate naphthalene, and wax alkylate phenol.

According to an embodiment of the present invention, the dispersion medium may be a blend of the oil and synthetic oil containing any one of synthetic diester, polyol ester, diisodecyl adipates, diisotridecyl adipates, poly alpha olefins, and oleates.

According to one embodiment of the present invention, the oil may be contained in an amount of 10 wt % to 90 wt % in the magnetorheological fluid.

According to one embodiment of the present invention, the additive may include a pour point depressant and the pour point depressant may be contained in an amount of 0.1 wt % to 0.5 wt % in the magnetorheological fluid.

According to one embodiment of the present invention, the oil may be contained in an amount of more than 0 but less than or equal to 50 wt % in the magnetorheological fluid.

According to one embodiment of the present invention, a viscosity may be 0.2 Pa's or less at a temperature of 40° C. and a shear rate of 800 to 1200/s.

According to one embodiment of the present invention, a shear stress may be greater than 50 kPa at a temperature of 25° C. and a shear rate of 1500/s.

According to one embodiment of the present invention, a sedimentation rate S of the magnetorheological fluid may be greater than at least 80%, where S (vol %)=100−[(ΔS)/(h)]×100 [ΔS represents the height of a supernatant liquid after a certain period of time after a cylinder is filled with a magnetorheological fluid, and h represents the initial height of the magnetorheological fluid filled in the cylinder].

According to one embodiment of the present invention, the oil may be contained in an amount of 10 wt % to 70 wt % in the magnetorheological fluid.

### Advantageous Effects

According to the present invention configured as described above, there is an effect of using an environmentally friendly dispersion medium and reducing manufacturing costs.

In addition, according to the present invention, there is an effect of having a relatively high flash point and enabling stable use in a high temperature range.

Furthermore, according to the present invention, there is an effect of having relatively high viscosity and density, which can prevent sedimentation of magnetic particles.

However, the scope of the present invention is not limited by such an effect.

### BRIEF DESCRIPTION OF DRAWINGS

FIG. 1 is a diagram showing the chemical structures of (a) rapeseed oil and (b) soybean oil according to an embodiment of the present invention.

FIG. 2 is a diagram showing the chemical structures of (a) linseed oil and (b) synthetic oil PAO (Poly Alpha Olefins) according to an embodiment of the present invention.

FIG. 3 is a diagram showing a chemical structure of a pour point depressant according to various embodiments of the present invention.

FIG. 4 is a diagram showing the chemical structures of (a) natural oil and (b) synthetic oil, poly alpha olefin (POA), according to an embodiment of the present invention.

FIG. 5 is a schematic diagram showing the shape and saturation of carbon chains, and pour point state according to an embodiment of the present invention.

FIG. 6 is a diagram showing the chemical structure of synthetic oil according to various embodiments of the present invention.

FIG. 7 is a diagram showing the forms of carbon bond in oil according to an embodiment of the present invention.

FIG. 8 is a graph showing flash points depending on natural oil content according to various embodiments of the present invention.

FIG. 9 is a graph showing pour points depending on natural oil content according to various embodiments of the present invention.

FIG. 10 is a graph showing flash points depending on pour point depressant content according to various embodiments of the present invention.

FIG. 11 is a graph showing pour points depending on pour point depressant content according to various embodiments of the present invention.

FIG. 12 is a graph showing viscosity depending on natural oil content according to various embodiments of the present invention.

FIG. 13 is a graph showing shear stress depending on natural oil content according to various embodiments of the present invention.

FIG. 14 is a schematic diagram showing sedimentation rate measurement of a magnetorheological fluid according to an embodiment of the present invention.

### MODE FOR INVENTION

In the following detailed description, reference is made to the accompanying drawings that show, by way of illustration, embodiments in which the invention may be practiced. These embodiments are described in sufficient detail to enable those skilled in the art to practice the invention. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, similar reference numerals refer to the same or similar functions over various aspects, and the length, area, thickness, and the like and the form may be exaggerated for convenience.

Hereinafter, preferred embodiments of the present invention will be described in detail with reference to the accompanying drawings so that those skilled in the art may easily implement the present invention.

In conventional magnetorheological fluids, synthetic oils are used as the dispersion medium. Typically, magnetorheological fluids employ synthetic oil-based poly alpha olefins (PAOs). However, these hydrocarbon-based synthetic oils are not easily decomposed, leading to challenges in disposal and environmental pollution. Additionally, they have relatively low flash points, posing a risk of significant accidents such as explosions in the event of a fire.

To address these issues, the present invention provides a magnetorheological fluid using natural oil. Magnetorheological fluids using natural oils obtained through plant extraction poses less risk of environmental damage in their manufacturing process. In addition, magnetorheological fluids using natural oils exhibit biodegradable characteristics, making them environmentally friendly. Additionally, magnetorheological fluids using natural oils have relatively high flash points, enabling stable use in a wide temperature range. Moreover, magnetorheological fluids using natural oils have high viscosity and density, preventing sedimentation of heavy magnetic particles and thus offering advantages in terms of sedimentation rate of magnetorheological fluids. Furthermore, magnetorheological fluids using natural oils can be supplied at a relatively low cost, resulting in significant reduction in manufacturing costs.

According to an embodiment of the present invention, a magnetorheological fluid may have a phase in which a liquid phase and a solid phase are converted or the liquid phase and the solid phase are mixed according to an external magnetic field. Magnetic particles included in the magnetorheological fluid may form a chain according to the external magnetic field, and thus exhibit properties similar to solids.

According to an embodiment of the present invention, the magnetorheological fluid may include a mixture of a dispersion medium, magnetic particles, and an additive.

The dispersion medium is a material that allows a magnetic powder composite to be dispersed to form a suspension, and has a polar or non-polar property, and a low viscosity is preferable for a maximum magnetorheological effect.

In particular, the dispersion medium of the present invention may contain natural oil. For example, the natural oil to be used may be one or more vegetable oils selected from the group consisting of rapeseed oil (canola oil or colza oil), soybean oil, linseed oil, peanut oil, cottonseed oil, corn oil, olive oil, coconut oil, soya oil, palm oil, grape seed oil, sunflower seed oil, safflower oil, hazelnut oil, marula oil, macadamia oil, mongongo oil, argan oil, almond oil, pine nut oil, cashew oil, pistachio oil, pecan oil, walnut oil, rice bran oil, mustard oil, neem oil, perilla oil, hemp seed oil, watermelon seed oil, avocado oil, sesame oil, palm kernel oil, castor oil, pumpkin seed oil, lemon oil, and orange oil.

In addition, the dispersion medium may have a kinetic viscosity at 40° C. in the range of approximately 5 to 300 mm²/s. If the kinematic viscosity is less than this range, there may be a problem of lowering a sedimentation property, and if the kinematic viscosity is greater than this range, there may be a problem of lowering the fluidity, so it is preferable that the kinematic viscosity is included in the range.

The magnetic particles may be at least one selected from iron, carbonyl iron, iron alloy, iron oxide, iron nitride, iron carbide, low carbon steel, nickel, cobalt, and mixtures thereof, or alloys thereof. For example, the magnetic particles may include iron oxide (Fe₂O₃) particles, iron oxide (Fe₃O₄) particles, carbonyl iron, or combinations thereof. The average diameter of the magnetic particles may be approximately 1 to 100 μm. Additionally, the magnetic particles may be uncoated or coated with an organic resin.

For example, the magnetic particles may be included in the magnetorheological fluid in an amount of approximately 65 to 85 wt %. If the magnetic particles are included in an amount less than this range, it may lead to a decrease in shear stress, while inclusion in an amount greater than this range may cause issues with fluidity. Thus, it is preferable to include the magnetic particles within this range.

Additionally, the magnetic particles may have various shapes such as spherical, cylindrical, or rod-like shapes. Preferably, when the particles are spherical, variations in magnetic properties due to changes in particle shape are minimized, resulting in uniform magnetorheological characteristics.

Moreover, for example, the magnetic particles may have a D50 diameter in the range of 1 μm to 50 μm. The D50 diameter represents the particle size corresponding to 50% of the cumulative distribution of solid particle size. The diameter may be measured using particle sizing methods such as laser diffraction. The D50 diameter of the magnetic particles influences the rheological characteristics of the magnetorheological fluid, and larger D50 diameter may indicate higher yield stress. However, excessively large D50 diameter may lead to precipitation and a decrease in fluid stability. Therefore, it is preferable for the magnetic particles of the present invention to have a D50 diameter in the range of 1 μm to 50 μm.

The additive of the magnetorheological fluid may include a pour point depressant. Besides, the magnetorheological fluid may include a thixotropic agent, a dispersion agent, an antifriction agent, an antioxidant, and a corrosion inhibitor as conventional additives.

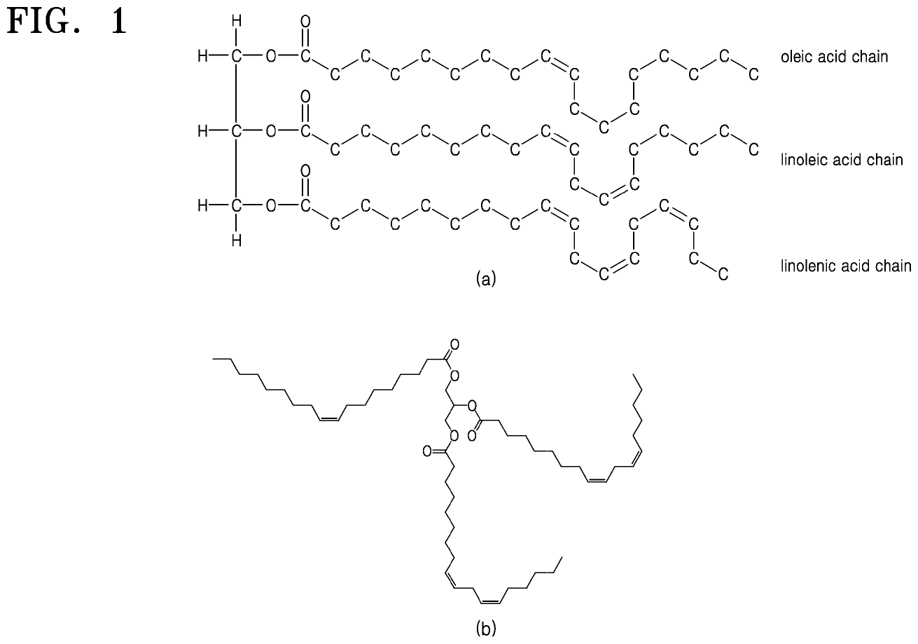

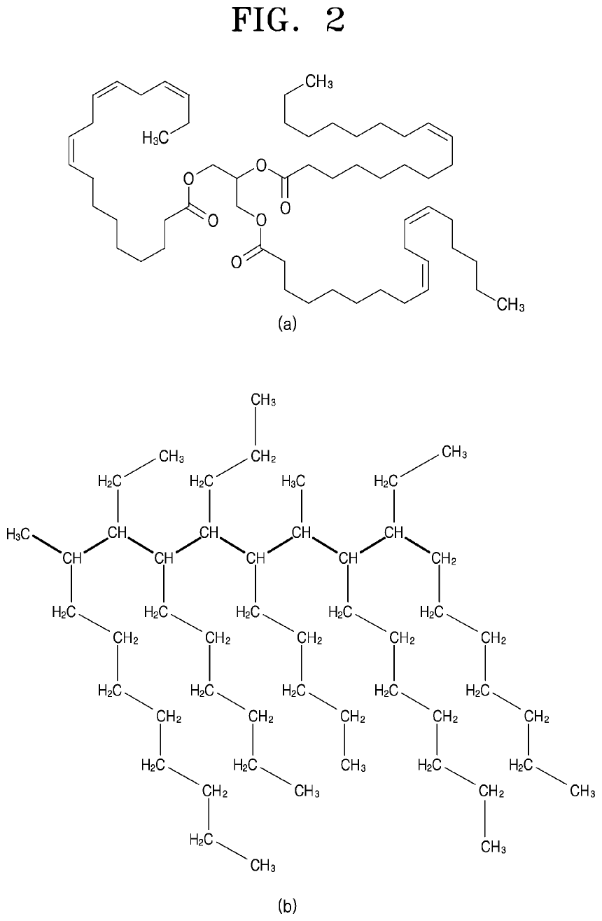

FIG. 1 is a diagram showing the chemical structures of (a) rapeseed oil and (b) soybean oil according to an embodiment of the present invention. FIG. 2 is a diagram showing the chemical structures of (a) linseed oil and (b) synthetic oil PAO (poly alpha olefin) according to an embodiment of the present invention.

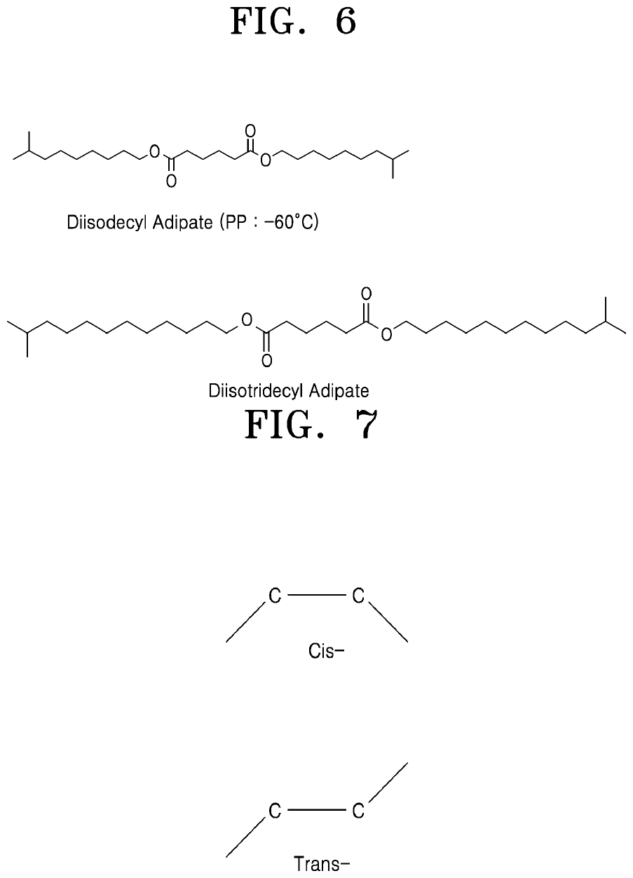

(a), and (b) of FIG. 1 and (a) of FIG. 2 depict the natural oil used in the dispersion medium of the present invention. For example, rapeseed oil in (a) of FIG. 1 is a mixture of 61 wt % of oleic acid, 19 wt % of linoleic acid, and 9 wt % of linolenic acid. In the form of triglyceride shown in (a) of FIG. 6, R′ is oleic acid, R″ is linoleic acid, and R′″ is linolenic acid.

Soybean oil in (b) of FIG. 1 is a mixture of 23 wt % of oleic oil, 51 wt % of linoleic acid, and 7 wt % of linolenic acid. Linseed oil in (a) of FIG. 2 is a mixture of 18 wt % of oleic oil, 13 wt % of linoleic acid, and 53 wt % of linolenic acid.

(b) of FIG. 2 shows poly alpha olefin (PAO) as an example of synthetic oil. PAO, synthetic oil, is mainly composed of hydrocarbons.

Table 1 below shows the physical properties of oils (PAO and natural oils) for a magnetorheological fluid.

TABLE 1

| | Viscosity | Density | Flash Point | Pour Point |
|---|---|---|---|---|
| | (Pa · s) | (g/cm3) | (° C.) | (° C.) |
| PAO | 0.036 | 0.797 | 160 | −73 |
| Rapeseed oil | 0.078 | 0.910 | 433 | −18 |
| Soybean Oil | 0.054 | 0.917 | 315 | −9 |
| Palm Oil | 0.032 | 0.895 | 615 | 23.6 |
| Coconut Oil | 0.055 | 0.910 | 563 | 24 |
| Sunflower Oil | 0.062 | 0.918 | 315 | −12 |
| Cottonseed Oil | 0.062 | 0.917 | 315 | 0 |
| Caster Oil | 0.580 | 0.959 | 145 | 2.7 |
| Linseed Oil | 0.033 | 0.930 | 94 | −24 |
| Tung Oil | 0.300 | 0.937 | 110 | — |

(* Linseed oil ignition point: 343° C.)

The flash point is the lowest temperature at which ignition occurs, representing the lowest temperature at which combustion can be initiated upon contact with an ignition source from outside. The ignition point refers to the lowest temperature at which self-ignition begins, representing the lowest temperature at which a fuel placed in air can initiate combustion without contacting an ignition source. The pour point refers to the lowest temperature at which fluidity and flow state are maintained when the temperature is lowered.

Natural oils, with vegetable oil as the main component, possess a triglyceride structure composed of ester bonds between glycerol (or glycerin) and fatty acids, or they have a molecular structure in the form of fatty acid alkyl esters. Due to this structure, natural oils have a higher pour point compared to synthetic oils primarily composed of paraffin. Additionally, fatty acids may be categorized into saturated fatty acids and unsaturated fatty acids. Examples of the saturated fatty acids include palmitic acid, stearic acid, and the like, and examples of the unsaturated fatty acids include oleic acid, linoleic acid, linolenic acid, and the like. They are differentiated based on the number of carbons and double bonds, and the types of natural oils may be classified according to the composition ratio of each fatty acid.

Natural oils have the drawback of higher fluidity compared to synthetic oils. Therefore, when natural oils are applied to shock absorbers (dampers), there is a risk of natural oils precipitating into a crystalline state at low temperatures, resulting in an increase in fluid viscosity and potentially causing reduced flowability and blockage of flow passages at low temperatures.

Shock absorbers for automobiles require stable operation across a temperature range from low to high, particularly maintaining a low pour point at a temperature of at least −30° C. or lower, preferably even at −40° C. or lower.

Accordingly, methods for reducing the pour point of the dispersion medium of a magnetorheological fluid are considered to ensure the stable operation of shock absorber.

Firstly, the use of pour point depressants may be considered. An additive such as a pour point depressant may be added in an appropriate amount to oil with a high pour point to lower the pour point.

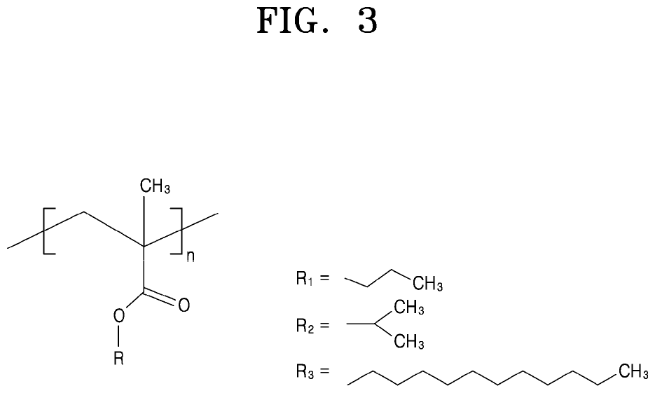

FIG. 3 is a diagram showing a chemical structure of a pour point depressant according to various embodiments of the present invention.

As depicted in FIG. 3, according to one embodiment, poly alkyl methacrylate may be used as a pour point depressant. In poly alkyl methacrylate, when R is R1, it is poly(butyl methacrylate) (PBMA), when R is R2, it is poly(isobutyl methacrylate) (PIBMA), and when R is R3, it is poly(lauryl methacrylate) (PLMA).

According to another embodiment, the pour point depressant may be vinyl carboxylate-dialkyl fumarate copolymers, alpha-olefin polymers and copolymers, dichlorobenznene, toluene, ethylene glycol monoethyl ether, dichloromethane, dichloroethane, wax alkylate naphthalene, wax alkylate phenol, etc.

Secondly, blending oils may be considered. Blending an appropriate amount of synthetic oil with natural oil may lower the pour point.

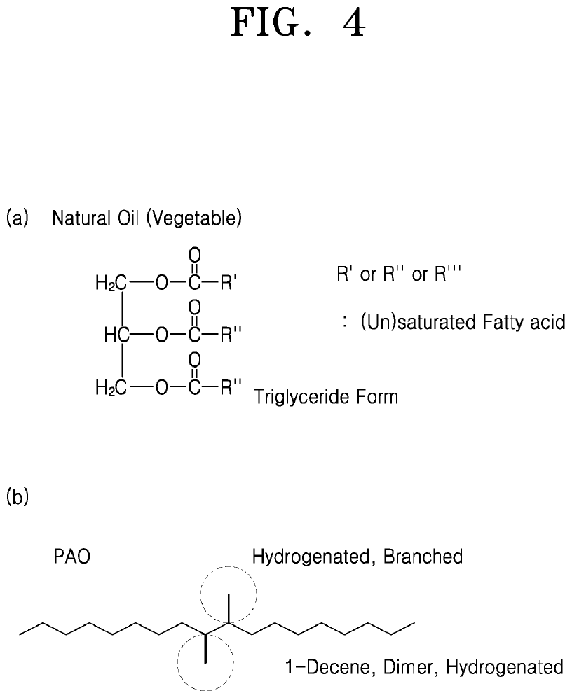

FIG. 4 is a diagram showing the chemical structures of (a) natural oil and (b) synthetic oil, poly alpha olefin (POA), according to an embodiment of the present invention.

Referring to FIG. 4, natural oil contains fatty acids with relatively long linear carbon chains compared to synthetic oil (typically, PAO), which has branched carbon chains. Therefore, the two oils differ in pour point. By blending oils with different pour points, the pour point of natural oil may be reduced.

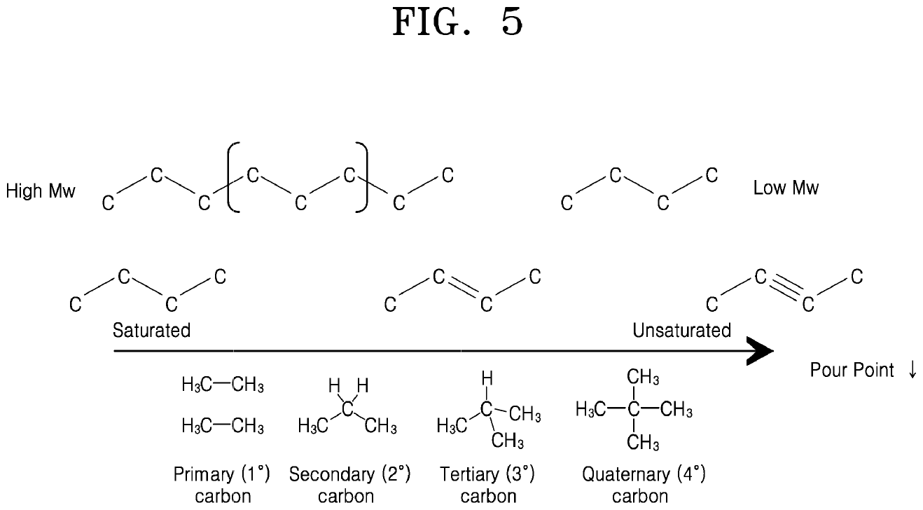

FIG. 5 is a schematic diagram showing the shape and saturation of carbon chains, and pour point state according to an embodiment of the present invention. FIG. 6 is a diagram showing the chemical structure of synthetic oil according to various embodiments of the present invention. FIG. 7 is a diagram showing the forms of carbon bond in oil according to an embodiment of the present invention.

Referring to FIG. 5, the pour point may be lower when the molecular structure is unsaturated rather than saturated. Molecular structure with higher molecular weight (High Mw) is saturated, while molecular structure with lower molecular weight (Low Mw) is unsaturated. When a carbon-carbon bond is a single bond in the molecular structure, it is saturated, whereas when a carbon-carbon bond is a triple bond in the molecular structure, it is unsaturated. In a hydrocarbon, as the central carbon forms primary, secondary, tertiary, and quaternary carbon bonds, it becomes more unsaturated.

For example, types of oils that can serve as diluents to lower the pour point through oil blending include synthetic diester, polyol ester, diisodecyl adipates, diisotridecyl adipates, poly alpha olefins, and oleates. FIG. 6 illustrates diisodecyl adipates and diisotridecyl adipates, which have, similarly to PAO, a branched carbon chain.

Referring to FIG. 7, in the chemical structure trend of oils that can be used to lower the pour point through oil blending, cis-formation is preferable over trans-formation. In other words, for lowering the pour point, an unsaturated chain structure is preferred over a saturated chain structure, and cis-formation is advantageous in forming the unsaturated structure.

In addition, structures with more hydroxy groups (hydrogen bonding) tend to exhibit lower pour points compared to those with less hydroxy groups.

Hereafter, oils blended with natural oil and synthetic oil are evaluated. The representative PAO is used as the synthetic oil. In Experimental Examples below, carbonyl iron magnetic particles are included in the magneticrheological fluid in an amount of approximately 70 to 80 wt %.

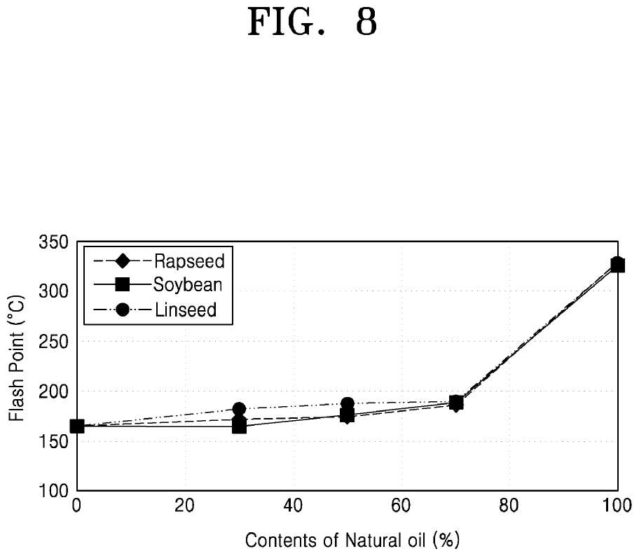

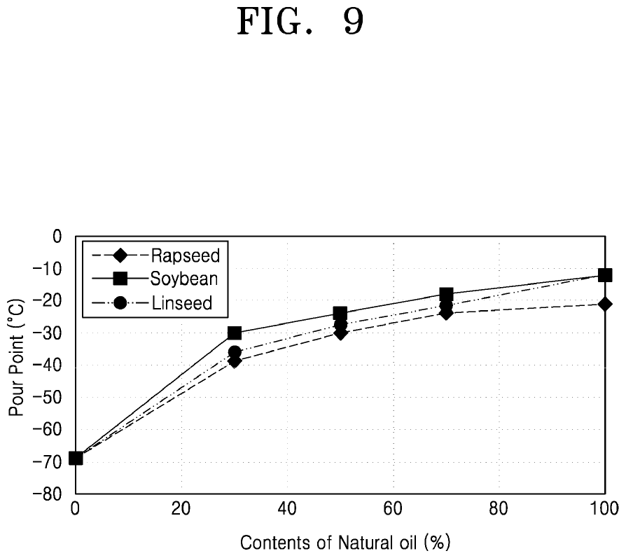

FIG. 8 is a graph showing flash points depending on natural oil content according to various embodiments of the present invention. FIG. 9 is a graph showing pour points depending on natural oil content according to various embodiments of the present invention.

In Table 2 below, samples #1 to #4 contain 100 wt % of PAO, rapeseed oil, soybean oil, and linseed oil, respectively. In Table 3, samples #5 to #7 are blends of PAO and rapeseed oil. Samples #8 to #10 are blends of PAO and soybean oil, and samples #11 to #13 are blends of PAO and linseed oil.

TABLE 2

| | Flash | Pour | | | | |
|---|---|---|---|---|---|---|
| Type | Point | Point | #1 | #2 | #3 | #4 |
| unit | ° C. | ° C. | % | % | % | % |
| PAO | 160 | −73 | 100 | 0 | 0 | 0 |
| Rapeseed oil | 433 | −18 | 0 | 100 | 0 | 0 |
| Soybean Oil | 315 | −9 | 0 | 0 | 100 | 0 |
| Linseed Oil | 94 | −24 | 0 | 0 | 0 | 100 |

| | | | | | |
|---|---|---|---|---|---|
| Evaluation | Flash Point | 164 | 328 | 326 | 330 |
| Result (° C.) | Pour Point | −69 | −21 | −12 | −12 |

(* Linseed oil ignition point: 343° C.)

TABLE 3

| | Flash | Pour | | | | | | | | | |
|---|---|---|---|---|---|---|---|---|---|---|---|
| Type | Point | Point | #5 | #6 | #7 | #8 | #9 | #10 | #11 | #12 | #13 |
| unit | ° C. | ° C. | % | % | % | % | % | % | % | % | % |
| PAO | 160 | −73 | 70 | 50 | 30 | 70 | 50 | 30 | 70 | 50 | 30 |
| Rapeseed oil | 433 | −18 | 30 | 50 | 70 | 0 | 0 | 0 | 0 | 0 | 0 |
| Soybean Oil | 315 | −9 | 0 | 0 | 0 | 30 | 50 | 70 | 0 | 0 | 0 |
| Linseed Oil | 94 | −24 | 0 | 0 | 0 | 0 | 0 | 0 | 30 | 50 | 70 |

| | | | | | | | | | | |
|---|---|---|---|---|---|---|---|---|---|---|
| Evaluation | Flash Point | 172 | 174 | 186 | 164 | 176 | 188 | 182 | 188 | 188 |
| Result (° C.) | Pour Point | −39 | −30 | −24 | −30 | −24 | −18 | −36 | −27 | −21 |

(* Linseed oil ignition point: 343° C.)

Referring to FIGS. 8 and 9 and Tables 2 and 3, it can be observed that the flash point tends to decrease as the content of PAO (synthetic oil) increases. It can be seen that the pour point tends to decrease as the content of PAO (synthetic oil) increases.

Shock absorbers (dampers) for automobiles need to maintain a pour point below at least −30° C., preferably below −40° C. It can be seen that samples #5, #6, #8, and #11 exhibit low pour points within this range. Considering this, in a magnetorheological fluid blended with natural oil and synthetic oil, the amount of natural oil may be greater than 0 but less than or equal to 50 wt %. Preferably, since samples #5, #8, and #11 show low pour points for each component, the amount of natural oil in the magneticrheological fluid may also be greater than 0 but less than or equal to 30 wt %.

Hereafter, the flash point and pour point are evaluated for different amounts of pour point control additive (pour point depressant) in natural oil.

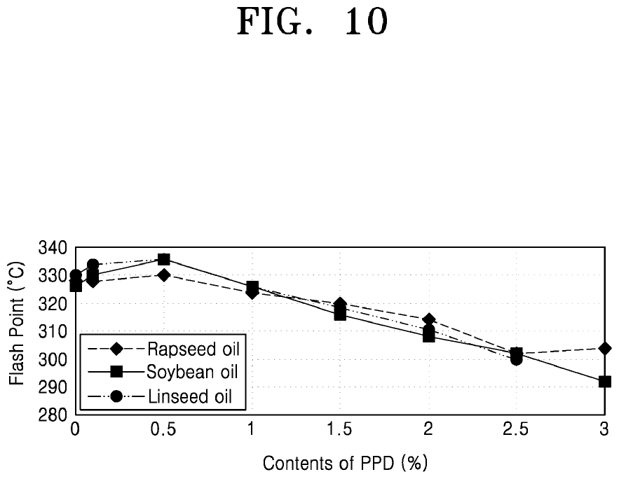

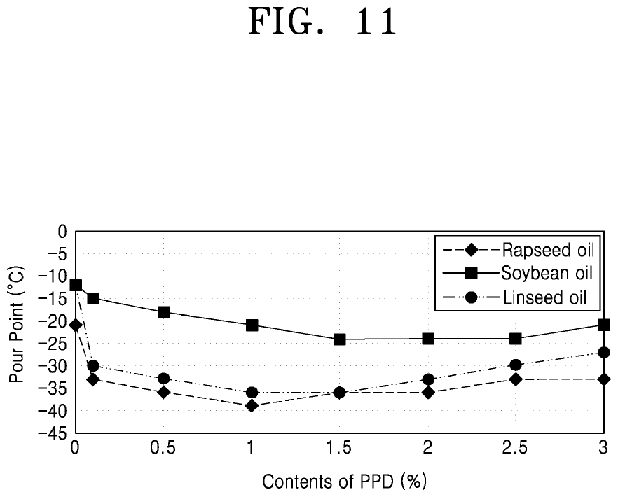

FIG. 10 is a graph showing flash points depending on pour point depressant content according to various embodiments of the present invention. FIG. 11 is a graph showing pour points depending on pour point depressant content according to various embodiments of the present invention.

In Tables 4 to 6 below, samples #1 to #8 are samples with different amounts of pour point depressant added to rapeseed oil, samples #9 to #16 are samples with different amounts of pour point depressant added to soybean oil, and samples #17 to #24 are samples with different amounts of pour point depressant added to linseed oil.

TABLE 4

| | Flash | Pour | | | | | | | | |
|---|---|---|---|---|---|---|---|---|---|---|
| Type | Point | Point | #1 | #2 | #3 | #4 | #5 | #6 | #7 | #8 |
| unit/PPD | ° C. | ° C. | 0 | 0.1 | 0.5 | 1.0 | 1.5 | 2.0 | 2.5 | 3.0 |
| content(%) | | | | | | | | | | |
| Rapeseed oil | 433 | −18 | 100 | 100 | 100 | 100 | 100 | 100 | 100 | 100 |

| | | | | | | | | | |
|---|---|---|---|---|---|---|---|---|---|
| Evaluation | Flash Point | 328 | 328 | 330 | 324 | 320 | 314 | 302 | 304 |
| Result (° C.) | Pour Point | −21 | −33 | −36 | −39 | −36 | −36 | −33 | −33 |

TABLE 5

| | Flash | Pour | | | | | | | | |
|---|---|---|---|---|---|---|---|---|---|---|
| Type | Point | Point | #9 | #10 | #11 | #12 | #13 | #14 | #15 | #16 |
| unit/PPD | ° C. | ° C. | 0 | 0.1 | 0.5 | 1.0 | 1.5 | 2.0 | 2.5 | 3.0 |
| content(%) | | | | | | | | | | |
| Soybean Oil | 315 | −9 | 100 | 100 | 100 | 100 | 100 | 100 | 100 | 100 |

| | | | | | | | | | |
|---|---|---|---|---|---|---|---|---|---|
| Evaluation | Flash Point | 326 | 330 | 336 | 326 | 316 | 308 | 302 | 292 |
| Result (° C.) | Pour Point | −12 | −15 | −18 | −21 | −24 | −24 | −24 | −21 |

TABLE 6

| | Flash | Pour | | | | | | | | |
|---|---|---|---|---|---|---|---|---|---|---|
| Type | Point | Point | #17 | #18 | #19 | #20 | #21 | #22 | #23 | #24 |
| unit/PPD | ° C. | ° C. | 0 | 0.1 | 0.5 | 1.0 | 1.5 | 2.0 | 2.5 | 3.0 |
| content(%) | | | | | | | | | | |
| Linseed Oil | 94 | −24 | 100 | 100 | 100 | 100 | 100 | 100 | 100 | 100 |

| | | | | | | | | | |
|---|---|---|---|---|---|---|---|---|---|
| Evaluation | Flash Point | 330 | 334 | 336 | 326 | 318 | 310 | 300 | 294 |
| Result (° C.) | Pour Point | −12 | −30 | −33 | −36 | −36 | −33 | −30 | −27 |

Referring to FIGS. 10 and 11, and Tables 4 to 6, it can be observed that there is a tendency for the flash point to be higher when the additive is present in an amount of 0.5% (samples #3, #11, and #19). In addition, for samples #1 to #8, the pour point generally tends to be lower when the additive is present in an amount of 0.1 to 3.0 wt %. Additionally, for samples #9 to #16, the pour point generally tends to be lower when the additive is present in an amount of 0.5 to 3.0 wt %. Moreover, for samples #18 to #24, the pour point generally tends to be lower when the additive is present in an amount of 0.1 to 3.0 wt %. Overall, it can be observed that the pour point tends to be lower when the additive is present in an amount of 0.5 to 2.5 wt %

Hereafter, the flash point and pour point are evaluated for different amounts of pour point depressant added to natural oil blended with PAO (synthetic oil).

Table 7 shows blends of PAO with each of rapeseed oil, soybean oil, and linseed oil at a ratio of 90 wt %: 10 wt %, to which a pour point depressant is added in various amounts. Table 8 shows blends of PAO with each of rapeseed oil, soybean oil, and linseed oil at a ratio of 10 wt %: 90 wt %, to which a pour point depressant is added in various amounts.

TABLE 7

| Type | #1 | #2 | #3 | #4 | #5 | #6 |
|---|---|---|---|---|---|---|
| PPD (% relative | 0.1 | 0.5 | 0.1 | 0.5 | 0.1 | 0.5 |
| to total Oil) | | | | | | |
| PAO | 90 | 90 | 90 | 90 | 90 | 90 |
| Rapeseed oil | 10 | 10 | | | | |
| Soybean Oil | | | 10 | 10 | | |
| Linseed Oil | | | | | 10 | 10 |
| Flash Point (° C.) | 160 | 158 | 164 | 166 | 162 | 160 |
| Pour Point (° C.) | −63 | −63 | −60 | −57 | −66 | −66 |

TABLE 8

| Type | #1 | #2 | #3 | #4 | #5 | #6 |
|---|---|---|---|---|---|---|
| PPD (% relative | 0.1 | 0.5 | 0.1 | 0.5 | 0.1 | 0.5 |
| to total Oil) | | | | | | |
| PAO | 10 | 10 | 10 | 10 | 10 | 10 |
| Rapeseed Oil | 90 | 90 | | | | |
| Soybean Oil | | | 90 | 90 | | |
| Linseed Oil | | | | | 90 | 90 |
| Flash Point (° C.) | 220 | 224 | 218 | 222 | 216 | 216 |
| Pour Point (° C.) | −36 | −39 | −18 | −24 | −33 | −39 |

Referring to Table 7, it can be observed that blending PAO with rapeseed oil, soybean oil, and linseed oil, along with the addition of pour point depressant, results in significantly low pour points, around −60° C. Additionally, referring to Table 8, it can be seen that blending just 10 wt % of PAO already leads to low pour points, near −40° C. That is, it is confirmed that magnetorheological fluids containing natural oil in an amount ranging from 10 wt % to 90 wt % exhibit low pour points around −40° C.

Furthermore, in magnetorheological fluids blended with natural and synthetic oil, it is confirmed that low pour points near −40° C. are achieved when the amount of pour point depressant ranges from 0.1 wt % to 0.5 wt %.

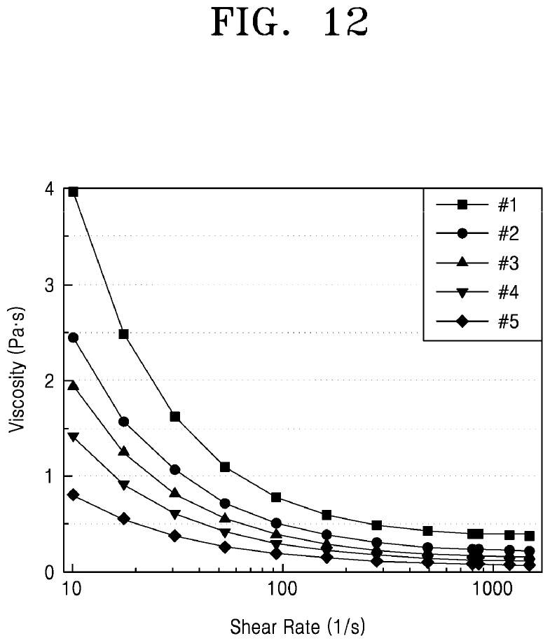

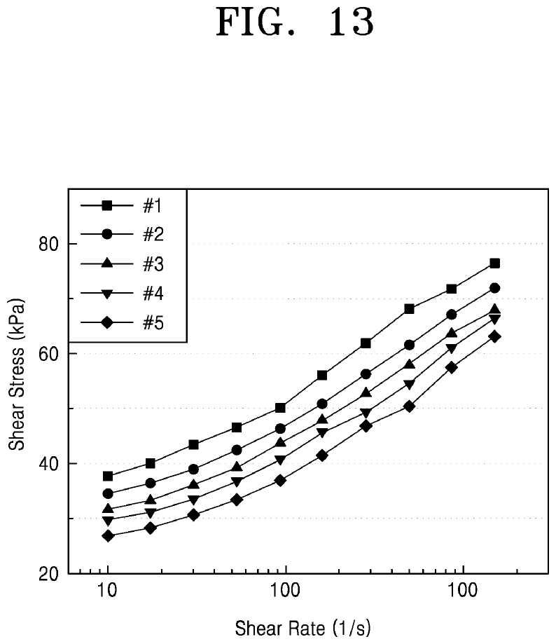

FIG. 12 is a graph showing viscosity depending on natural oil content according to various embodiments of the present invention. FIG. 13 is a graph showing shear stress depending on natural oil content according to various embodiments of the present invention.

Below, evaluations of viscosity and shear stress are conducted for blends of natural oil and PAO (synthetic oil), along with the addition of a pour point depressant, according to the varying content of natural oil and synthetic oil.

Table 9 shows the mixing ratios of PAO, linseed oil, and pour point depressant (PPD) for each sample. Table 10 presents the viscosity for each sample at shear rates of 10/s, 250/s, and 1500/s. Table 11 shows the average viscosity for each sample at shear rates ranging from 800 to 1200/s. The viscosity is measured at 40° C.

TABLE 9

| Mixing Ratio (%) | #1 | #2 | #3 | #4 | #5 |
|---|---|---|---|---|---|
| PAO | 0 | 30 | 50 | 70 | 100 |
| Linseed Oil | 100 | 70 | 50 | 30 | 0 |
| PPD | 0.5 | 0.5 | 0.5 | 0.5 | 0.5 |

TABLE 10

| | Viscosity [Pa · s] | | | | |
|---|---|---|---|---|---|
| | #1 | #2 | #3 | #4 | #5 |
| 10/s | 3.96 | 2.44 | 1.94 | 1.41 | 0.80 |
| 250/s | 0.48 | 0.30 | 0.22 | 0.17 | 0.11 |
| 1500/s | 0.38 | 0.22 | 0.15 | 0.11 | 0.07 |

TABLE 11
Viscosity [Pa · s] (800-1200/s slope)

| #1 | #2 | #3 | #4 | #5 |
|---|---|---|---|---|
| 0.357 | 0.199 | 0.137 | 0.096 | 0.056 |

Referring to FIG. 12 and Table 11, it can be observed that the viscosity tends to increase as the content of natural oil increases. Additionally, it can be seen that viscosity tends to increase as the shear rate decreases. Particularly, it is ideal for the viscosity to remain below 1.5 Pa's regardless of the shear rate, as seen in sample #4 of FIG. 12.

Furthermore, as shown in Table 11, it is preferable for the viscosity to be below 0.2 Pa's at shear rates of 800-1200/s. In other words, when the amount of natural oil is less than 70 wt % at the shear rate ranging from 800 to 1200/s, the viscosity may be less than or equal to 0.2 Pa·s. Considering Tables 7 and 8 together, it can be considered ideal for the amount of natural oil in a magnetorheological fluid to range from 10 wt % to 70 wt % to achieve a viscosity below 0.2 Pa·s.

Table 12 presents the shear stress for each sample at shear rates of 10/s, 250/s, and 1500/s. The shear stress is measured at 25° C. under a magnetic field of 0.571T.

TABLE 12

| | Shear Stress [kPa] | | | | |
|---|---|---|---|---|---|
| | #1 | #2 | #3 | #4 | #5 |
| 10/s | 37.8 | 34.4 | 31.4 | 29.7 | 26.8 |
| 250/s | 61.9 | 56.2 | 52.7 | 49.4 | 46.9 |
| 1500/s | 76.4 | 71.9 | 67.9 | 66.4 | 63.2 |

Referring to FIG. 13 and Table 12, it can be observed that the shear stress tends to increase as the content of natural oil increases. Considering FIG. 12 and Tables 10 and 11 together, it appears that the shear stress is influenced by viscosity. Particularly, it can be seen that at a shear rate of 1500/s, all samples exhibit shear stress of 50 kPa or more.

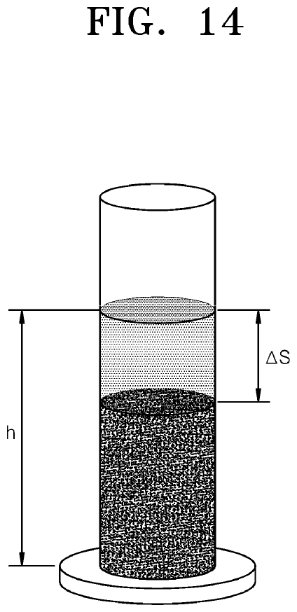

FIG. 14 is a schematic diagram showing sedimentation rate measurement of a magnetorheological fluid according to an embodiment of the present invention.

Referring to FIG. 14, a sedimentation rate S may be measured as follows.

$$S ( vol \% ) = 100 - [ ( Δ S ) / ( h ) ] \times 100$$

Here, ΔS represents the height of a supernatant liquid after a certain time after filling a cylinder with the magnetorheological fluid, and h represents the initial height of the cylinder filled with the magnetorheological fluid. The supernatant liquid refers to the upper layer separated by the sedimentation of the magnetic particles in the magnetorheological fluid. For example, the degree of sedimentation may be measured at every set time after filling the magnetorheological fluid into a container maintained horizontally, considering the state where no sedimentation has occurred as 100%. Additionally, for example, in order for the magnetorheological fluid to have excellent sedimentation stability and be used in practice, a sedimentation rate of 80% or more may be required when measured after natural sedimentation for 60 days.

Table 13 shows the sedimentation rate for each sample from Table 9. A cylinder is filled with a magnetorheological fluid and a sedimentation rate is measured 7 days later.

TABLE 13
Sedimentation Rate (%)

| #1 | #2 | #3 | #4 | #5 |
|---|---|---|---|---|
| 96.3 | 92.7 | 89.18 | 84.5 | 78.2 |

Referring to Table 13, it can be observed that samples #1 to #4 with natural oil added have improved sedimentation rate compared to sample #5 containing only synthetic oil. Considering Tables 7 and 8 together, it can be considered preferable for the amount of natural oil in the magnetorheological fluid to range from 10 wt % to 70 wt % to achieve a sedimentation rate of 80% or higher. As described above, the magnetorheological fluid of the present invention utilizes an environmentally friendly dispersion medium, enables reduction in manufacturing costs, has a relatively high flash point, allows for stable operation in a high temperature range, and possesses relatively high viscosity and density to prevent sedimentation of magnetic particles. Although the present invention has been shown and described with reference to a preferred embodiment as described above, the present invention is not limited to the above embodiment, and within the scope without departing from the spirit of the present invention, various modifications and changes can be made by those skilled in the art. It should be considered that such modification example and change example belong to the scopes of the present invention and the appended claims.

1. A magnetorheological fluid whose flow characteristics change in response to the application of an external magnetic field, the magnetorheological fluid comprising:
a dispersion medium containing oil;
magnetic particles; and
an additive,
wherein the oil has a triglyceride structure composed of ester bonds between glycerol and fatty acid.

2. The magnetorheological fluid of claim 1, wherein the oil comprises at least one of the following: rapeseed oil (canola oil or colza oil), soybean oil, linseed oil, peanut oil, cottonseed oil, corn oil, olive oil, coconut oil, soya oil, palm oil, grape seed oil, sunflower seed oil, safflower oil, hazelnut oil, marula oil, macadamia oil, mongongo oil, argan oil, almond oil, pine nut oil, cashew oil, pistachio oil, pecan oil, walnut oil, rice bran oil, mustard oil, neem oil, perilla oil, hemp seed oil, watermelon seed oil, avocado oil, sesame oil, palm kernel oil, castor oil, pumpkin seed oil, lemon oil, and orange oil.

3. The magnetorheological fluid of claim 1, wherein the magnetic particles are iron, carbonyl iron, iron alloy, iron oxide, iron nitride, iron carbide, low carbon steel, nickel, cobalt, and mixtures thereof, or alloys thereof.

4. The magnetorheological fluid of claim 1, wherein the additive comprises a pour point depressant.

5. The magnetorheological fluid of claim 4, wherein the pour point depressant is contained in an amount of 0.1 wt % to 3.0 wt % in the magnetorheological fluid.

6. The magnetorheological fluid of claim 4, wherein the pour point depressant is contained in an amount of 0.5 wt % to 2.5 wt % in the magnetorheological fluid.

7. The magnetorheological fluid of claim 1, wherein the additive comprises poly alkyl methacrylate (poly alkyl methacrylate), or comprises any one of vinyl carboxylate-dialkyl fumarate copolymers, alpha-olefin polymers and copolymers, dichlorobenzene, toluene, ethylene glycol monoethyl ether, dichloromethane, dichloroethane, wax alkylate naphthalene, and wax alkylate phenol.

8. The magnetorheological fluid of claim 1, wherein the dispersion medium is a blend of the oil and synthetic oil containing any one of synthetic diester, polyol ester, diisodecyl adipates, diisotridecyl adipates, poly alpha olefins, and oleates.

9. The magnetorheological fluid of claim 8, wherein the oil is contained in an amount of 10 wt % to 90 wt % in the magnetorheological fluid.

10. The magnetorheological fluid of claim 9, wherein the additive comprises a pour point depressant and the pour point depressant is contained in an amount of 0.1 wt % to 0.5 wt % in the magnetorheological fluid.

11. The magnetorheological fluid of claim 8, wherein the oil is contained in an amount of more than 0 but less than or equal to 50 wt % in the magnetorheological fluid.

12. The magnetorheological fluid of claim 1, wherein a viscosity is 0.2 Pa's or less at a temperature of 40° C. and a shear rate of 800 to 1200/s.

13. The magnetorheological fluid of claim 1, wherein a shear stress is greater than 50 kPa at a temperature of 25° C. and a shear rate of 1500/s.

14. The magnetorheological fluid of claim 1, wherein a sedimentation rate S of the magnetorheological fluid is greater than at least 80%, where S (vol %)=100−[(ΔS)/(h)]×100 [ΔS represents the height of a supernatant liquid after a certain period of time after a cylinder is filled with the magnetorheological fluid, and h represents the initial height of the magnetorheological fluid filled in the cylinder].

15. The magnetorheological fluid of claim 12, wherein the oil is contained in an amount of 10 wt % to 70 wt % in the magnetorheological fluid.
